(19) United States
(12) Patent Application Publication
(10) Pub. No.: US 2005/0002333 A1
(43) Pub. Date: Jan. 6, 2005

(54) Emulated multi-QoS links

(75) Inventors: Michael L. Aalders, Nepean (CA); Kim K. Edwards, Orleans (CA); Dwight D. Jamieson, Ottawa (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 10/463,330

(22) Filed: Jun. 18, 2003

(51) Int. Cl. H04L 12/56

(52) U.S. Cl. 370/230; 370/465

(57) ABSTRACT

An emulated multi-QoS link provides an application-level Connection (e.g. a Multi-Protocol Label Switching (MPLS) E-LSP) with the capability of receiving or transmitting messages of various QoS levels over an interconnection employing a connection-oriented protocol (e.g. ATM) at the data link layer. The emulated multi-QoS link may provide the application managing the application-level Connection (e.g. MPLS) with a control plane Application Programming Interface (API) like that of a multi-QoS link which may provide link status based on the status of underlying connections at the data link layer. The connection-oriented or non connection-oriented nature of the data link layer protocol is transparent to an application instance using the emulated multi-QoS link. Advantageously, emulated multi-QoS links may simplify merging in the case where the application is MPLS.

### FIELD OF THE INVENTION

The present invention relates to communications, and more particularly to communications links which employ connection-oriented protocols, non connection-oriented protocols, or combinations of these, at the data link layer.

### BACKGROUND OF THE INVENTION

In a communications network, message traffic is typically routed by way of links. Links are physical or logical interconnections between network nodes (e.g. routers or switches). Physical links may comprise optical fiber, coaxial cable or other transmission media. Logical links behave like physical links but are not necessarily associated with a dedicated physical transmission medium.

The Open Systems Interconnection (OSI) model defines seven layers for data communications. The second layer, or OSI layer 2, is referred to as the “data link layer”. At this layer, two different types of protocols may be employed: connection-oriented protocols and non connection-oriented protocols.

Connection-oriented protocols provide multiple connections over a physical or logical link. Each connection typically carries messages (e.g. packets) of a particular Quality of Service (QoS) level. A QoS level is essentially a desired level or threshold of service for a connection across a network. QoS characteristically includes a “mission priority” or importance parameter. For example, in voice communications, emergency or “911” calls may be assigned a QoS with a higher importance than standard telephone calls so that the routing of packets associated with these calls may be prioritized according to importance, to ensure that 911 calls have a higher priority than standard calls.

With a connection-oriented protocol, therefore, the number of connections on a particular link is at least as large as the number of different QoS levels of messages being sent over the link. The messages of one connection are multiplexed with messages of other connections for transmission across the link and then demultiplexed when received.

An example of a connection-oriented protocol is the Asynchronous Transfer Mode (ATM) protocol. ATM is capable of providing multiple connections, referred to as Virtual Channel Connections (VCCs), over a single physical or logical link, with each VCC carrying messages of a particular QoS level. Other examples of connection-oriented protocols include the Frame Relay and Time Division Multiplexing (TDM) protocols.

Non connection-oriented protocols, on the other hand, do not provide multiple connections. Rather, messages of all QoS levels are sent over the same link, with an indication of QoS level being associated, either explicitly or implicitly, with each message. Examples of non connection-oriented protocols include Packet Over Sonet (POS) or Ethernet (e.g. Gigabit Ethernet or “GigE”).

A single-QoS link is a link that is capable of sending and receiving messages of a single QoS level and which appears to the user to be a dedicated link. Single-QoS links are often implemented over a single connection provided by a connection-oriented protocol (e.g. an ATM VCC). Single-QoS links typically provide a “control plane” Application Programming Interface (API) for the purpose of providing link status information (e.g. “up” or “down” link status) to an application (as hereinafter defined) or to provide transmit or receive queue identifiers to the application. Single-QoS links may also provide a “data plane” API for the purpose of sending and receiving packets over the single-QoS link, if the link transmit media (as also defined hereinafter) is implemented in software.

A multi-QoS link is a link that is capable of sending and receiving messages of any QoS level. All of the messages sent or received by a multi-QoS link are carried over the same “pipe” with an indication of the QoS level being associated with each message. As with single-QoS links, multi-QoS links provide a control plane API capable of providing link status information or queue information to an application, and may provide data plane API when the link transmit media is implemented in software. Non connection-oriented protocols are often used to implement multi-QoS links.

A combination of single-QoS links and multi-QoS links may exist in one communications network.

The users of single-QoS links and multi-QoS links are typically applications. For clarity, the term “application” (and “application layer”) as used herein does not refer to the application layer of the OSI model (i.e. OSI layer 7). Rather, the term “application” refers to an overlying network protocol or set of functions operating at OSI layers 2 and/or 3. An example of an application is Multi-Protocol Label Switching (MPLS). MPLS is described in Request For Comments (RFC) 3270, which is available at http://www.ietf.org/rfc.html, which RFC is hereby incorporated by reference hereinto. Briefly, MPLS is a framework of functions comprising enhancements to OSI layer 2 and layer 3 technologies which permits label switching to be introduced into OSI layer 2 and/or layer 3 protocols. In an initialization stage of MPLS, a unique label is assigned to the links of a network by a Label Distribution Protocol (LDP) executed at each network node, effectively creating Label Switched Paths (LSPs) which span the network. An LSP is an example of an application-level Connection. Application-level Connections, which are referenced herein with a leading capital “C”, should be distinguished from data-link layer connections, such as an ATM VCCs, which are referenced herein entirely in lower case. During a subsequent execution stage, messages are routed along the LSPs according to assigned labels rather than OSI Layer 3 headers, as follows: packets entering the network are assigned labels consistent with the LSP links along which they are to travel first. At each node, the label of an incoming packet is swapped with a new label identifying the next LSP link along which the packet is to travel, and the packet is switched to the next node accordingly. The process continues until the packet reaches its destination node. MPLS thus allows packets to be switched based on labels using simple lookups (e.g. table lookups) rather than being routed based on OSI Layer 3 headers, which is more burdensome.

Applications such as MPLS typically use single-QoS links and multi-QoS links differently. When an application is to employ single-QoS links to send and receive messages at a particular node, the application typically employs application-level Connections that only send or receive messages of a particular QoS level. A separate application-level Connection is typically instantiated for each single-QoS link to be employed, i.e. for each QoS level of messages to be sent or received (although two application-level Connections may employ the same single-QoS link when both Connections carry messages of the same QoS). For each single-QoS link employed, the application may interact with the link's control plane API to determine link status and queue information and, in the case where a data plane API is employed, with the data plane API to send and receive messages. In the case where the application is MPLS, the application-level Connections may be Label-Only-Inferred-PSC LSPs (L-LSPs). An L-LSP is essentially a link established by MPLS which provides a single QoS which can be inferred from the labels associated with messages traveling on the link. A more detailed explanation of L-LSPs is provided in RFC 3270 (referenced above).

As may be appreciated, the use of single-QoS links can disadvantageously consume significant resources and cause significant overhead to be incurred when message traffic is sent at a number of QoS levels. This is due to the fact that the number of application-level Connections and single-QoS links required to send and receive this message traffic is normally at least as large as to the number of QoS levels of messages to sent or received. As the number of QoS levels increases, so too does the amount of overhead incurred from the management of multiple application-level Connections and single-QoS links during operation. Further, the single-QoS model does not provide desired treatment or behavior without the use of costly additional links or a more expensive, faster link engineered to eliminate congestion. For example, each packet of a particular QoS may be assigned the same emission priority with the single-QoS model.

In contrast, when an application has access to a multi-QoS link at a particular node, the application can employ an application-level Connection that is capable of sending or receiving messages of multiple QoS levels. In the case of MPLS, the application-level Connection may be an EXP-Inferred-PSC LSP (E-LSP), which is essentially a single link established by MPLS which provides multiple QoS levels, where the QoS of each message is explicitly indicated in the message header. For each multi-QoS link employed, the application interacts with the control plane API to determine link status and queue information and, in the case where a data plane API is employed, with the data plane API to send and receive messages.

Multi-QoS links address some of the above-noted disadvantages associated with single-QoS links. Specifically, when a multi-QoS link is used, it may only be necessary for an application (e.g. MPLS) to manage one link and one application-level Connection (e.g. E-LSP) regardless of the number of QoS levels being employed. Also, unlike the case when many single-QoS links of different QoS levels are used, it may be unnecessary to use QoS as a search key to identify a link of appropriate QoS along which to forward a message. This can reduce the amount of control functionality required to determine and maintain tables. Overall, the amount of network engineering and operations that is necessary to set up and maintain the network may be reduced due to a reduction in the number of links.

Because multi-QoS links require a non connection-oriented protocol such as POS or GigE to be employed at the data link layer, known techniques do not permit a multi-QoS link to be implemented using connection-oriented data link layer protocols such as ATM or Frame Relay, at least not with the simplicity and appearance to an application of a multi-QoS link (i.e. providing the application with the ability to send or receive a message over a link regardless of QoS level, and in the case of sending messages, without identifying an underlying connection having a suitable QoS level for transmitting the message). As a result, networks which employ connection-oriented data link layer protocols are currently precluded from attaining some or all of the aforementioned benefits associated with multi-QoS links.

A problem arising in the case of networks employing both single-QoS and multi-QoS links and operating MPLS at the application layer is that merging of LSPs may be difficult. The term “merging” refers to the previously described LDP process of replacing labels associated with incoming messages at a network node with an outgoing label. Merging is described in detail in RFC 3031, which is available at http://www.ietf.org/rfc.html and is incorporated by reference hereinto. The merging of LSPs is complex when some LSPs are L-LSPs and others are E-LSPs, as will be the case due to the existence of both single-QoS links and multi-QoS links in the network. For non-MPLS applications which perform multiplexing and demultiplexing of connections (e.g. Virtual Local Area Network or VLAN), this type of “merging” may also be complicated.

What is needed is a type of data communications link that overcomes at least some of the above-noted disadvantages.

### SUMMARY OF THE INVENTION

An emulated multi-QoS link provides an application-level Connection (e.g. a Multi-Protocol Label Switching (MPLS) E-LSP) with the capability of receiving or transmitting messages of various QoS levels over an interconnection employing a connection-oriented protocol (e.g. ATM) at the data link layer. The emulated multi-QoS link may provide the application managing the application-level Connection (e.g. MPLS) with a control plane Application Programming Interface (API) like that of a multi-QoS link which may provide link status based on the status of underlying connections at the data link layer. The connection-oriented or non connection-oriented nature of the data link layer protocol is transparent to an application instance using the emulated multi-QoS link. Advantageously, emulated multi-QoS links may simplify merging in the case where the application is MPLS.

In accordance with an aspect of the present invention there is provided a method of emulating a multi-QoS (Quality of Service) link, comprising: from an application-level Connection, providing messages of various QoS levels for transmission as to a multi-QoS link capable of transmitting messages of various QoS levels; and transmitting each of said provided messages of a particular QoS level over one of a plurality of connections established by a connection-oriented protocol at the Open System Interconnections (OSI) data link layer suitable for transmitting messages of said particular QoS level.

In accordance with another aspect of the present invention there is provided a computer readable medium storing computer-executable instructions which, when performed by a processor in a computing device, cause the computing device to emulate a multi-QoS (Quality of Service) link by: from an application-level Connection, providing messages of various QoS levels for transmission as to a multi-QoS link capable of transmitting messages of various QoS levels; and transmitting each of said provided messages of a particular QoS level over one of a plurality of connections established by a connection-oriented protocol at the Open System Interconnections (OSI) data link layer suitable for transmitting messages of said particular QoS level.

In accordance with still another aspect of the present invention there is provided a computing device for emulating a multi-QoS (Quality of Service) link operable to: from an application-level Connection, provide messages of various QoS levels for transmission as to a multi-QoS link capable of transmitting messages of various QoS levels; and transmit each of said provided messages of a particular QoS level over one of a plurality of connections established by a connection-oriented protocol at the Open System Interconnections (OSI) data link layer suitable for transmitting messages of said particular QoS level.

In accordance with yet another aspect of the present invention there is provided an Application Programming Interface (API) having functions comprising: link status functions capable of: indicating a status of an emulated multi-QoS link capable of carrying messages of various QoS (Quality of Service) levels over a plurality of connections established by a connection-oriented protocol at the Open System Interconnections (OSI) data link layer, said status being based on the operational status of said connections.

In accordance with still another aspect of the present invention there is provided an Application Programming Interface (API) having functions comprising: message transmitting functions capable of: from an application-level Connection, receiving messages of various QoS (Quality of Service) levels which have been provided for transmission as to a multi-QoS link capable of transmitting messages of various QoS levels; and transmitting each of said provided messages of a particular QoS level over one of a plurality of connections suitable for transmitting messages of said particular QoS level, whereby the application-level Connection regards said API to be that of a multi-QoS link.

In accordance with yet another aspect of the present invention there is provided a computer readable medium storing computer-executable instructions which, when performed by a processor in a computing device, cause the computing device to: from an application-level Connection, provide messages of various QoS levels for transmission as to a multi-QoS link capable of transmitting messages of various QoS levels; and transmit each of said provided messages of a particular QoS level over one of a plurality of single-QoS links suitable for transmitting messages of said particular QoS level.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate an example embodiment of this invention:

FIG. 1 is a schematic diagram illustrating a network employing exemplary embodiments of the present invention;

FIG. 2 is a schematic diagram illustrating an exemplary end-to-end E-LSP created across the network of FIG. 1 using embodiments of the present invention;

FIG. 3 is a schematic diagram illustrating ingress components of an emulated multi-QoS link exemplary of the present invention;

FIG. 4 is a schematic diagram illustrating an egress components of another emulated multi-QoS link exemplary of the present invention;

FIG. 5 is a schematic diagram illustrating an exemplary packet which may be transmitted over the emulated multi-QoS links of FIGS. 3 and 4;

FIG. 6 is a schematic diagram illustrating a sink tree of E-LSPs, including the E-LSP of FIG. 2, established in the network of FIG. 1;

FIG. 7A is a flowchart illustrating control plane operation of the emulated multi-QoS links of FIGS. 3 and 4;

FIG. 7B is another flowchart illustrating data plane operation of the emulated multi-QoS links of FIGS. 3 and 4;

FIG. 8 is a schematic diagram illustrating an exemplary packet which may be sent across the last hop of the E-LSP of FIG. 2; and

FIG. 9 is a schematic diagram illustrating egress components of another emulated multi-QoS link exemplary of the present invention for transmission of messages over two interconnections.

### DETAILED DESCRIPTION

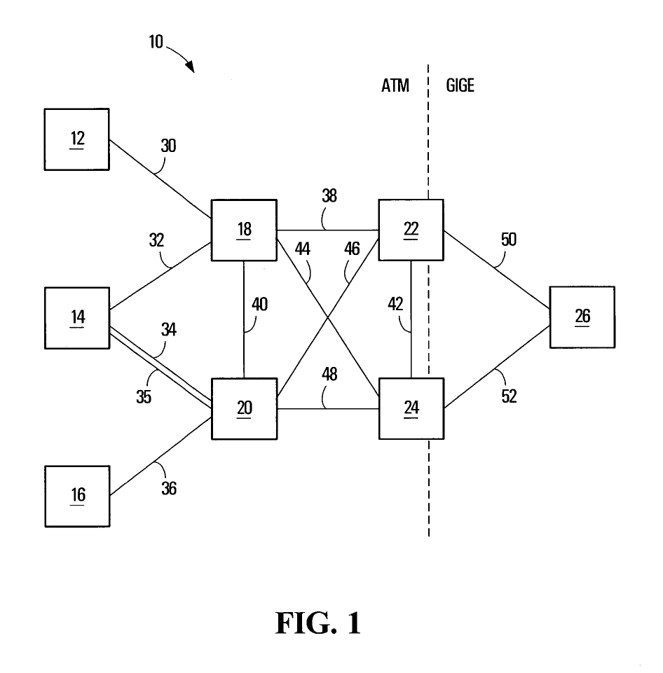

FIG. 1 is a schematic diagram illustrating a communications network 10 employing emulated multi-QoS links exemplary of the present invention over each of its interconnections. The network has eight nodes 12, 14, 16, 18, 20, 22, 24 and 26. Each node is a router or switch, such as Nortel Networks® Passport™ 7400 or Passport™ 15000, Juniper™ Networks M160 Router, Laure Networks ST200™ Service Edge Router, the Marconi ASX4000 switch-router, the Cisco® 7500 and the RiverStone Networks™ RS 8000 for example.

Interconnections 30, 32, 34, 35, 36, 38, 40, 42, 44, 46, 48, 50 and 52 between the various nodes are physical links capable of carrying message traffic. Interconnections 30, 32, 34, 35, 36, 38, 40, 42, 44, 46, 48, 50 and 52 may for example be optical fiber, coaxial cable, or another transmission medium known to those skilled in the art. Alternatively, the interconnections could be logical links rather than physical links.

Two different communications protocols are employed at Open Systems Interconnection (OSI) layer 2 (data link layer) of the network 10. Interconnections 30, 32, 34, 35, 36, 40, 42, 44, 46 and 48 employ Asynchronous Transfer Mode (ATM) at the data link layer. The particular ATM version in this example is ATM Adaptation Layer 5. In contrast, interconnections 50 and 52 employ the Ethernet protocol, specifically Gigabit Ethernet (GigE), at the data link layer. As known in the art, ATM is a connection-oriented protocol while Ethernet is a non connection-oriented protocol.

In the communications network 10, the Multi-Protocol Label Switching (MPLS) application operates at OSI layers 2 and/or 3. One instance of MPLS resides at each network node (not illustrated).

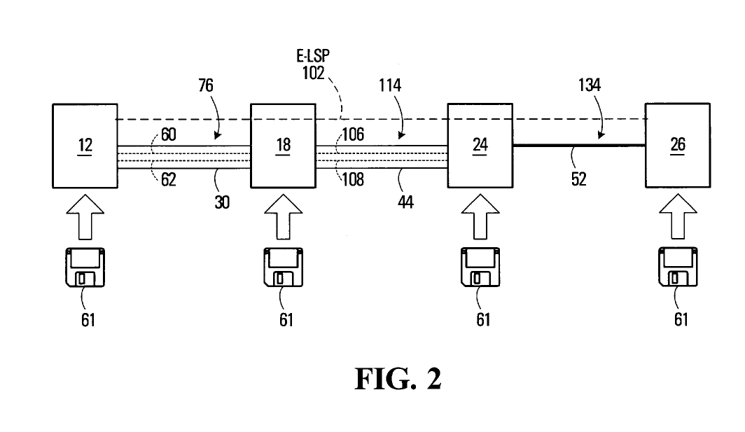

FIG. 2 is a schematic diagram illustrating an end-to-end EXP-Inferred-PSC Label Switched Path (E-LSP) 102 as created by the MPLS application across network 10. E-LSP 102 spans interconnections 30, 44, and 52, defining three “hops” between nodes 12 and 18, nodes 18 and 24, and nodes 24 and 26 respectively. For clarity, the E-LSP 102 illustrated in FIG. 2 is understood not to comprise a separate physical interconnection between nodes 12, 18, 24 and 26 from interconnections 30, 44 and 52, but rather operates at OSI layers 2 and/or 3 over the interconnections 30, 44 and 52, to provide an end-to-end path between nodes 12 and 26.

An emulated multi-QoS link 76 exemplary of the present invention operates over interconnection 30. The emulated multi-QoS link 76 carries message traffic for the E-LSP 102 over the interconnection 30. The message traffic carried by emulated multi-QoS link 76 is actually carried over two connections 60 and 62, which are ATM Virtual Channel Connections (VCCs) in the present example. Each connection 60 and 62 carries messages of a particular QoS level.

In a similar fashion, a second emulated multi-QoS link 114 exemplary of the present invention operates over interconnection 44, also carrying message traffic for the E-LSP 102. The message traffic carried by emulated multi-QoS link 114 is carried over two connections 106 and 108, also ATM VCCs, each also carrying messages of a particular QoS level. Connections 60 and 106 carry messages of the same pair of QoS levels, as do connections 62 and 108. It will be appreciated that the number of data link layer connections (and thus the number of QoS levels) over interconnections 30 and 44 could be larger or smaller than two in alternative embodiments. It will also be appreciated that different links may have different numbers of connections in alternative embodiments.

A third emulated multi-QoS link 134 carrying message traffic for the E-LSP 102 operates over interconnection 52. In this case, no connections are provided at the data link layer. Rather, all messages are carried over the same “pipe”, regardless of QoS level. As will be appreciated, the emulated multi-QoS link 134 emulates a multi-QoS link, in this case “sitting on top of” an actual multi-QoS link.

Emulated multi-QoS links 76, 114 and 134 may be implemented through software executing at network nodes 12, 18, 24 and 26. This software may be loaded for execution from a computer readable medium, such as a removable magnetic or optical disk 61, as illustrated in FIG. 2.

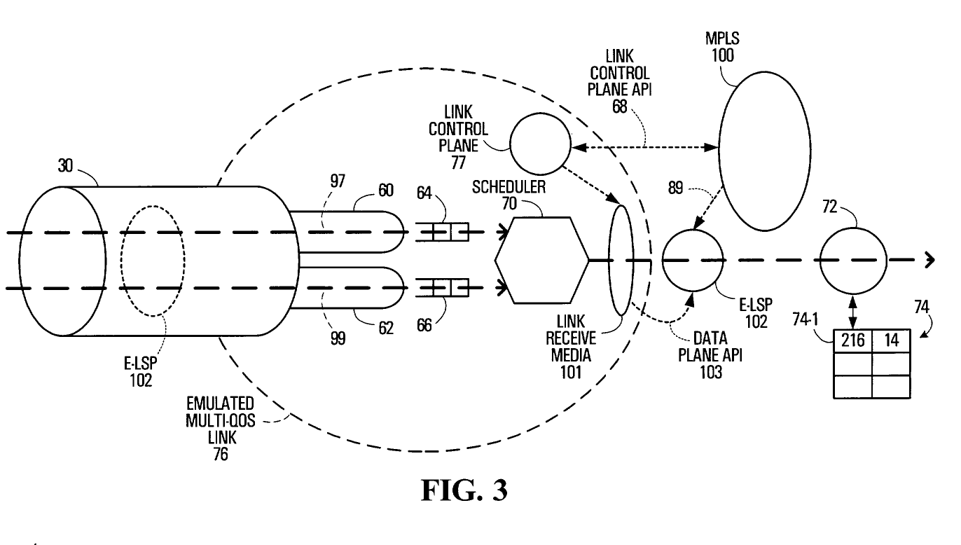

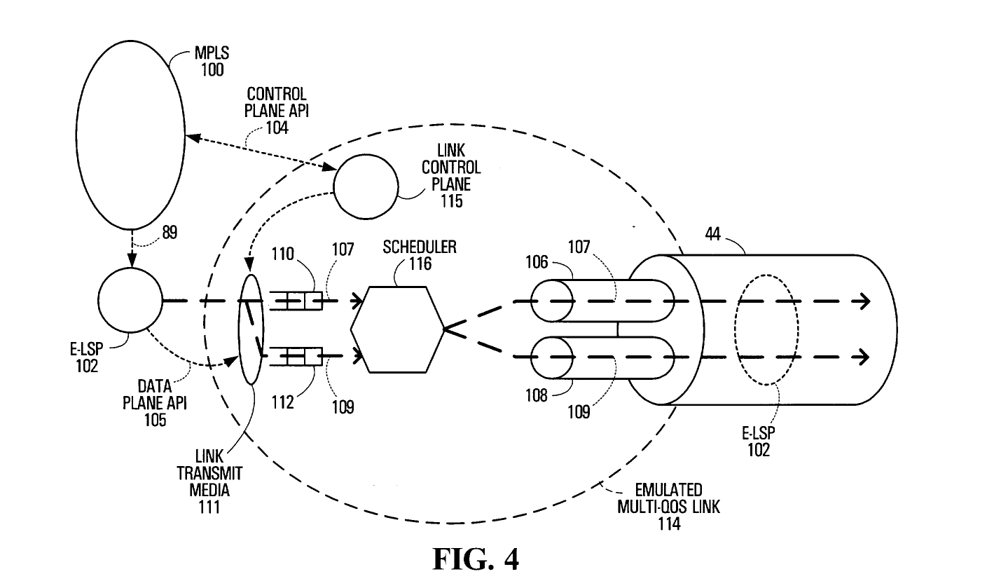

FIGS. 3 and 4 illustrate components of the emulated multi-QoS links 76 and 114 of E-LSP 102 in greater detail. In particular, FIG. 3 illustrates ingress components of the emulated multi-QoS link 76 used for receiving messages from interconnection 30 at node 18 while FIG. 4 illustrates egress components of the emulated multi-QoS link 114 used for sending messages over interconnection 44 from node 18. In FIGS. 3 and 4, dashed lines are understood to represent data flow while dotted lines represent control flow.

Referring to FIG. 3, the emulated multi-QoS link 76 is illustrated notionally at 76. Emulated multi-QoS link 76 may take the form of a process executing at node 18.

The emulated multi-QoS link 76 has a pair of receive queues 64 and 66. Receive queue 64 is for receiving messages of one QoS level while receive queue 66 is for receiving messages of another QoS level. The receive queues 64 and 66 may employ a message discard policy which discards received messages based their priority and the current congestion. level (e.g. number of enqueued messages versus queue capacity).

Emulated multi-QoS link 76 further includes a scheduler 70 which schedules the switching of messages received over the link 76 at node 18. Schedulers are well-known in the art.

Also included in emulated multi-QoS link 76 is link receive media 101 which receives packets carried by E-LSP 102. The link receive media 101 is essentially a representation of an application-level Connection (here, E-LSP 102) from the perspective of the emulated multi-QoS link 76. In the present embodiment the link receive media 101 is implemented in software, thus a data plane API 103 is provided to facilitate the receipt of packets. However, alternative embodiments may implement the link receive media 101 in hardware (e.g. as an application specific integrated circuit), in which case no data plane API 103 would be employed.

Emulated multi-QoS link 76 further includes a link control plane 77 which provides an API 68 for reporting link status (e.g. “up” or “down”) as well as queue identifiers of the link's receive queues 64 and 66 to the application 100 residing at node 18. Application 100 is the Multi-Protocol Label Switching (MPLS) application. The application 100 manages E-LSP 102 as indicated by control flow 89.

Also present at node 18 is a routing/switching engine 72. Routing/switching engine 72 performs routing/switching of messages which have been scheduled for routing/switching by the scheduler 70. The routing/switching engine 72 consults a routing/switching table 74 for this purpose.

Routing/switching table 74 is a lookup table which correlates incoming message labels with labels that should be swapped for said incoming message labels when the messages are forwarded along the next hop in a path through the network 10, in accordance with MPLS conventions. For illustration, table 74 contains a single entry 74-1 which indicates that any incoming messages having a label of “216” should have a label “14” swapped therefor when the message is forwarded to the next node along E-LSP 102 (i.e. when the message is forwarded from node 18 to node 24—see FIG. 2). The MPLS application could set up an alternate path in the table 74 for the E-LSP to use under a failure scenario if desired.

It should be appreciated that the routing/switching table 74 is associated with the interconnection 30 over which messages having a label of “216” are expected. Another table similar to table 74 but containing different label information would be stored for each other interconnection providing incoming traffic to the same network node.

It should also be appreciated that the routing/switching engine 72 and routing/switching table 74 could actually be referred to as switching engine 72 and switching table 74 respectively, in view of the fact that the application MPLS of the present embodiment only performs switching (not routing). Other embodiments could however perform routing.

In FIG. 3, the E-LSP 102 entering node 18 over interconnection 30 may be considered to consist of two data flows 97 and 99, each carrying data of a separate QoS level, and each being associated with a separate connection 60, 62 and a separate receive queue 64, 66 (respectively). The E-LSP 102 exiting the scheduler 70 and spanning the routing/switching engine 72 is understood to carry messages of both QoS levels.

For clarity, it will be appreciated that the various components illustrated in FIG. 3 are hosted at node 18.

Turning to FIG. 4, emulated multi-QoS link 114 is illustrated notionally at 114. Emulated multi-QoS link 114 has a link control plane 115 which provides an API 104 for reporting link status (e.g. “up” or “down”) as well as queue identifiers of the link's transmit queues 110 and 112 to the application 100 residing at node 18.

Emulated multi-QoS link 114 includes link transmit media 111 which is responsible for enqueueing packets comprising E-LSP 102 into a pair of transmit queues 110 and 112 based on QoS level. The link transmit media 111 is essentially a representation of the application-level Connection (E-LSP 102) from the perspective of the emulated multi-QoS link 114. The link transmit media 111 is implemented in software in the present embodiment and accordingly provides a data plane API 105 to facilitate the transmission of packets over link 114. The link transmit media could alternatively be implemented in hardware, in which case no data plane API 105 would be provided.

Each of transmit queues 110 and 112 enqueues messages of a different QoS level which application 100 is desirous of transmitting over interconnection 44 using E-LSP 102. The transmit queues 110 and 112 may employ a message discard policy which discards messages based their priority and the current congestion level.

Emulated multi-QoS link 114 further includes a scheduler 116 which schedules the transmission of messages over connections 106 and 108 by the emulated multi-QoS link 114. The scheduler 116 may adopt various scheduling approaches to select the next message to be transmitted from the queues 110 and 112, such as the priority approach or the waited fair queuing approach, both of which are known.

In FIG. 4, the E-LSP 102 may be considered to consist of two data flows 107 and 109, each carrying data of a separate QoS level, and each being associated with a separate transmit queue 110, 112 and a separate connection 106, 108 (respectively). The data flows 107 and 109 exiting over interconnection 44 cumulatively comprise E-LSP 102.

It will be appreciated that the various components illustrated in FIG. 4 are also hosted at node 18.

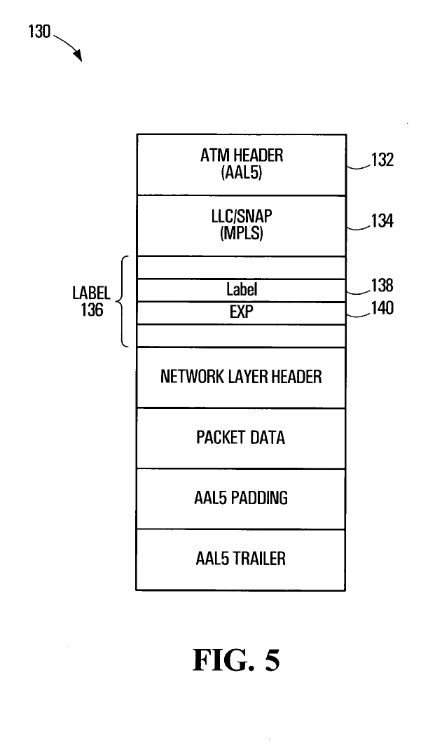

FIG. 5 illustrates an exemplary message as may be sent over emulated multi-QoS links 76 or 114 (i.e. the first two hops of E-LSP 102). Packet 130 includes various fields which notably include an ATM header field 132 identifying the ATM protocol as ATM Adaptation Layer 5, LLC/SNAP fields 134 which identify the relevant application to be MPLS, and a Label field 136. The Label field 136 includes a Label 138 storing the current MPLS label associated with the message and an EXP 140 which indicates the QoS level associated with the message.

Operation of the present embodiment occurs in two stages: an initialization stage and an execution stage.

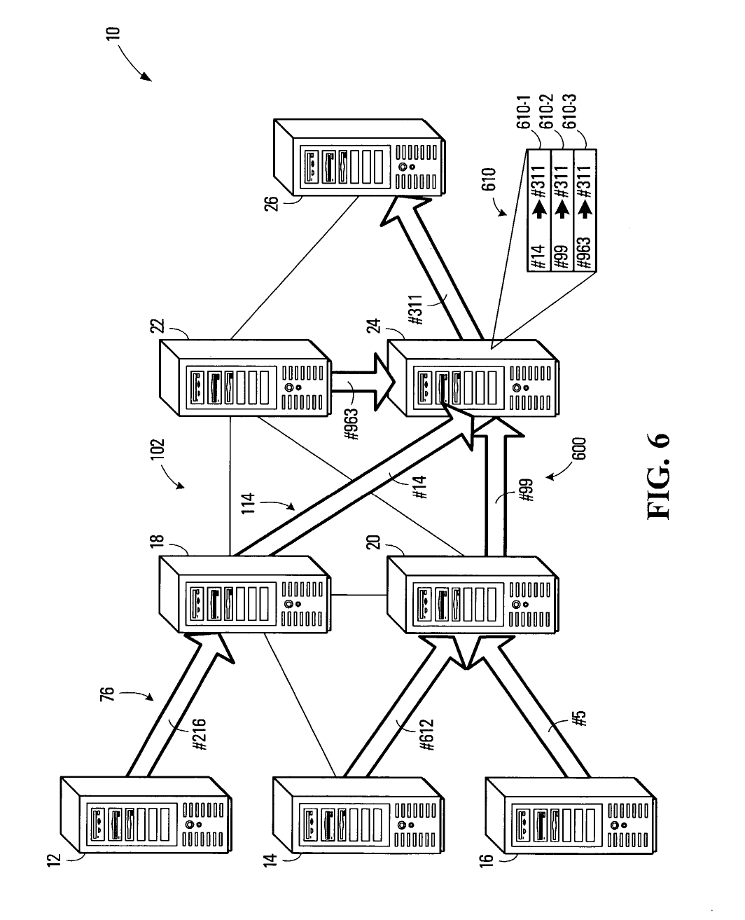

In the initialization stage, the Label Distribution Protocol (LDP) associated with MPLS is executed at each node of the network 10 (FIG. 1). Labels are distributed by way of the known “downstream-on-demand” or “downstream unsolicited” modes of label distribution. This causes a sink tree 600 of E-LSPs to be established in the network as illustrated in FIG. 6. The sink tree 600 encompasses E-LSP 102.

As can be seen in FIG. 6, the branches of sink tree 600 span not only interconnections employing non connection-oriented protocols at the data link layer, but also interconnections employing connection-oriented data link layer protocols (e.g. interconnections 30, 34, 36, 44 and 48). As will be appreciated, it is the use of emulated multi-QoS links over these interconnections which permits MPLS to create E-LSPs over interconnections employing connection-oriented links. More specifically, E-LSPs may be created over these interconnections because emulated multi-QoS links (such as links 76 and 114) are capable of interacting with MPLS application instances in the same manner as multi-QoS links. That is, MPLS application instances are not required to map multiple single-QoS L-LSP segments to or from E-LSP segments or other L-LSP segments.

During establishment of the sink tree 600, routing/switching tables at each network node, such as routing/switching table 74 (FIG. 3), are populated with label values which effect the routing/switching shown in the sink tree 600.

An exemplary routing/switching table 610 is shown in FIG. 6 at node 24. Table 610 has three entries, 610-1, 610-2, and 610-3, which entries map the incoming label values “14”, “99” and “963” (respectively) to an outgoing value “311”. These entries will effect switching of messages received from any of nodes 18, 20 and 22 (respectively) at node 24 to a destination node 26 during the execution stage of operation.

Operation of the emulated multi-QoS links of the present embodiment is further considered to occur in two “planes”, namely, the control plane and the data plane.

In the control plane, the link control plane (i.e. link management code) of each emulated multi-QoS link reports an operational status (e.g. “link up” or “link down”) to the application based on the status of its underlying connections. Various aggregation policies may be employed in assigning a status to link a based on the status of its underlying connections. In the present example a link is deemed to be “up” when all of its underlying connections are operational. Of course, in alternative embodiments, the link may be deemed to be “up” if one or more underlying connection is operational or if some percentage of underlying connections are operational.

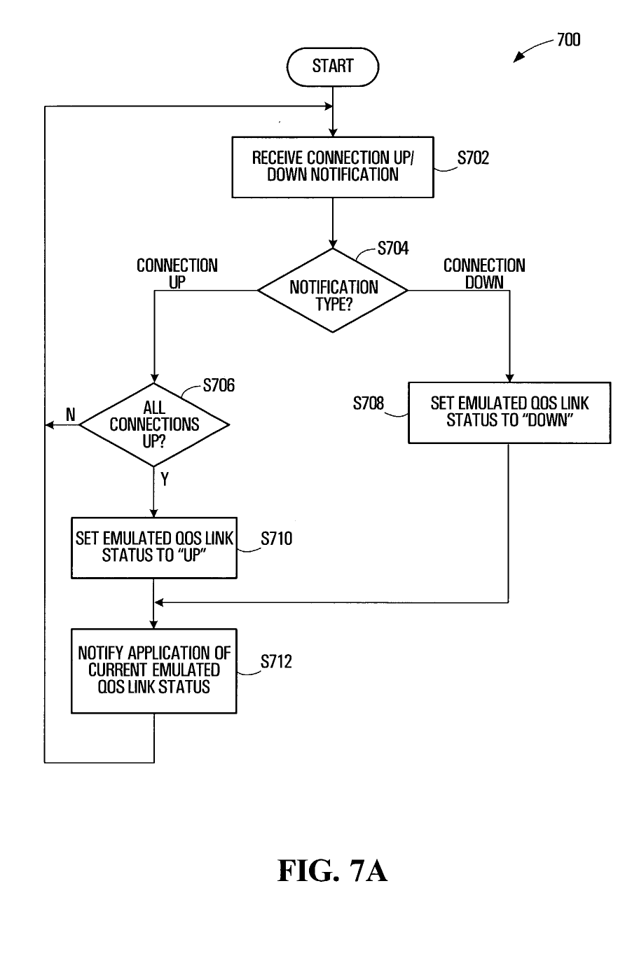

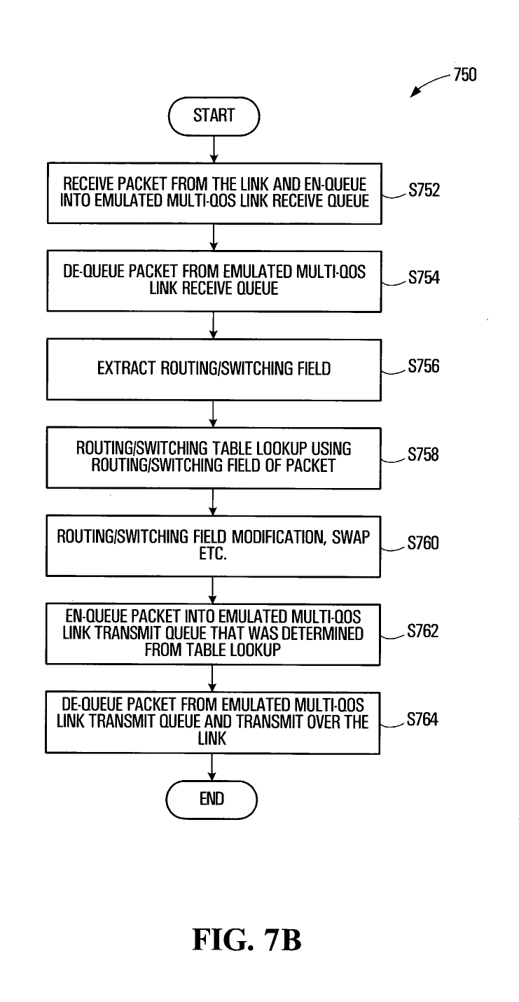

Operation 700 of the link control plane is illustrated in FIG. 7A. For purposes of illustration, operation 700 will be described in respect of emulated multi-QoS link 76 and application 100 operating at node 18 (FIG. 3). In this case operation 700 is that of the link control plane 77. It is assumed that both connections 60 and 62 which underlie emulated multi-QoS link 76 are initially “down” and that the link status 76 is also initially “down”. It is further assumed that the application 100 has notified emulated multi-QoS link 76 that it is waiting for the link 76 to come up. In accordance with the operative aggregation policy, the link 76 can only be deemed “up” when both of the underlying connections 60 and 62 are deemed “up” (although this aggregation policy may differ in alternative embodiments, as noted above, in which case the flowchart of FIG. 7A may have a different composition that will be apparent to a person skilled in the art).

Initially, the emulated multi-QoS link 76 receives notice that that connection 60 has come up (S702, S704). Because the other connection 62 is still down (S706), the emulated multi-QoS link status remains “down”. Subsequently, the emulated multi-QoS link 76 receives notice that that connection 62 has also come up (S702, S704). As all of the connections 60, 62 are now operational (S706), the emulated multi-QoS link status is set to “up” (S710), and the link control plane 77 notifies the application 100 of this status by way of link control plane API 68 (S712). In the event that status of either connection 60 or 62 were to change to “down”, so too would the status of the emulated multi-QoS link 76 (S708), with the change in status also being communicated to the application instance 100 (S712).

It should be noted that operation 700 continues throughout execution stage (i.e. is not limited just to network initialization).

It will be appreciated that operation 700 permits the application 100 to receive link status information regarding emulated multi-QoS link 76 as if link 76 was a multi-QoS link, despite the fact that the emulated multi-QoS link 76 actually employs connections (ATM VCCs) at the data link layer. This is made possible by the operation of link control plane 77, as described above, which shields the application 100 from the burden of managing individual connections. From the perspective of the application 100. Control-plane interaction of the application 100 with the emulated multi-QoS link 76 is simplified as compared to a case where a number of single-QoS links are exist atop the data link layer connections, in which case the application 100 might interact with each of the single-QoS links on the control plane.

Also occurring in the control plane, although not shown in FIG. 7A, the emulated multi-QoS links 76 and 114 provide identifiers for their receive and transmit queues to the application 100.

Once the emulated multi-QoS links 76 and 114 have reported that they are “up”, the application instance 100 may begin communicating in the data plane with other application instances in the network 10 to establish the E-LSPs of the sink tree 600. Establishing the sink tree 600 may include binding of routing/switching engine 72 to receive flows and updating of routing/switching table 74 with path information.

Turning to the data plane, during the execution stage messages are transmitted across the network 10 along the E-LSPs of sink tree 600. FIG. 7B illustrates operation 750 in the data plane at an exemplary node 18 (FIG. 2) during the execution stage. Other network nodes operate similarly.

For the purposes of the present description, it is assumed that a packet 130 (FIG. 5) originating from node 12 and ultimately destined for node 26 is traveling along emulated multi-QoS link 76 of E-LSP 102 (FIG. 2), and that the QoS level of packet 130 is such that the packet 130 will arrive at node 18 on connection 60.

Initially, the incoming packet 130 is received over connection 60 of interconnection 30 (FIG. 3) and enqueued into the associated receive queue 64 of emulated multi-QoS link 76 (S752). Next, the scheduler 70 invokes a method of link receive media 101 for receiving a packet, specifying receive queue 64 (S754) as the queue from which a packet is to be dequeued. This method dequeues the packet 130 from the receive queue 64 for routing/switching by the routing/switching engine 72.

Next, the routing/switching engine 72 extracts the routing/switching field of the packet 130 (S756). In the case where the application is MPLS, as in the present embodiment, the routing/switching field will be the MPLS Label field 138 (FIG. 5). In the present example, the Label field 138 contains a value of “216” in accordance with its transmission over the first hop of E-LSP 102.

The routing/switching engine 72 uses this extracted label “216” as a key to perform a lookup in routing/switching table 74 (S758). This lookup yields entry 74-1 (FIG. 3), which indicates that any packet having a label of “216” should have its label swapped with the value “14” before the packet is forwarded to the next node in the E-LSP 102. The value “216” of Label field 138 is accordingly swapped with the value “14” (S760).

For clarity, the operation of S756 to S760 is performed by the E-LSP 102 of application 100.

Subsequently, assuming that link control plane 115 for emulated multi-QoS link 114 has indicated a link status of “up” (FIG. 4), E-LSP 102 invokes a method of link transmit media 111 for transmitting an MPLS packet, causing the packet 130 having the swapped label value to be enqueued into an appropriate transmit queue for its QoS level, which in this example is transmit queue 110 (S762). Subsequently the scheduler 116 dequeues the packet 130 and transmits it over the appropriate connection for its QoS level, i.e., over connection 106 (S764).

It will be appreciated that operation at S762 to S764 permits a single application-level Connection (i.e. E-LSP 102) to transmit packets of different QoS levels over interconnection 44 without being required to specify the data link layer connection over which the packet should be sent. This is possible because, while the emulated multi-QoS link 114 presents an appearance of a multi-QoS link to the application-level Connection (i.e. E-LSP 102), link transmit media 111 (FIG. 4) ensures that packets destined for transmission over interconnection 44 are enqueued in the proper transmit queue. This allows a single application-level Connection (E-LSP 102) to be instantiated rather than multiple application-level Connections (e.g. two L-LSPs). The application 100 is thus shielded from the burden of selectively employing different application-level Connections (L-LSPs) to send packets of different QoS levels, as would be the case if single-QoS links were to overlie each of connections 106 and 108 without an emulated multi-QoS link 114.

Operation 750 completes with a loop back to S752 to prepare for receipt of the next incoming message.

It will be appreciated that receipt and transmission of messages as in S752 and S764 respectively will be suspended for an emulated multi-QoS link having a “down” status.

Operation at node 24 (FIG. 2) to receive packet 130 and forward it to its ultimate destination of node 26 is the same as operation 750 at node 18. One distinction is the fact that, after the packet 130 is received at node 24 over emulated multi-QoS link 114, its composition is changed before the packet is forwarded over emulated multi-QoS link 134 due to the use of distinct data link layer protocols (Gigabit Ethernet instead of ATM Adaptation Layer 5) over these links. This change is, however, transparent at the application layer.

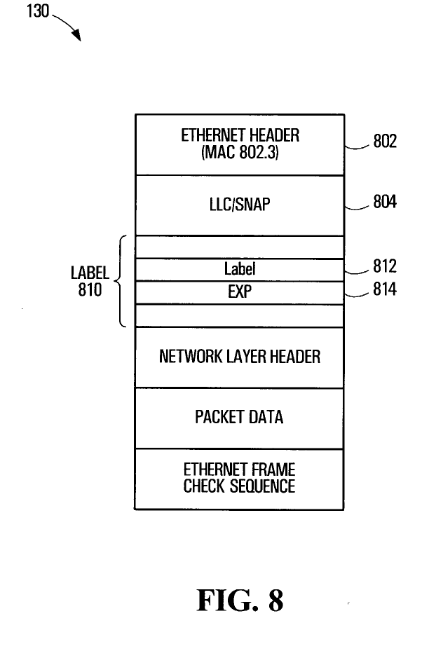

An exemplary format for the changed packet 130 is shown in FIG. 8. Packet 130 has various fields which notably include an Ethernet header field 802 specifying Ethernet MAC 802.3, LLC/SNAP fields 804 which identify the relevant application to be MPLS, and a Label field 810. The Label field 810 includes a Label 812 storing the current MPLS label associated with the packet and an EXP 814 which indicates the QoS level associated with the message.

It is noted that, during operation S762 to S764 at node 24, the emulated multi-QoS link 134 may act as a “front end” for a multi-QoS link operating over the interconnection 52.

As should be apparent from the above description, the use of emulated multi-QoS links such as links 76, 114 and 134 effectively decouples the application layer from the data link layer. In other words, connection-oriented or non connection-oriented nature of the operative data link layer protocol is made transparent to the application. In view of this fact, embodiments of the present invention may be employed to facilitate link by link conversion of networks from connection-oriented data link layer protocols to non connection-oriented data link layer protocols (or vice versa). For example, emulated multi-QoS links may be implemented in a network initially exclusively employing connection-oriented protocols at the data link layer. As network links are converted to support non connection-oriented protocols, the application layer is not impacted.

It should also be apparent that the use of emulated multi-QoS links such as 76, 114 and 134 facilitates merging of LSPs, as in the sink tree 600 of FIG. 6. Without emulated multi-QoS links, E-LSPs could only be implemented over interconnections employing non connection-oriented protocols at the data link layer. Interconnections employing connection-oriented data link layer protocols would be required to use L-LSPs. As known in the art, it is difficult to merge L-LSPs with E-LSPs. By using emulated multi-QoS links, E-LSPs are implemented throughout the network, and merging is accordingly simplified.

A similar benefit is provided to applications other than MPLS which multiplex connections together or de-multiplex them, such as Virtual Local Area Network or VLAN.

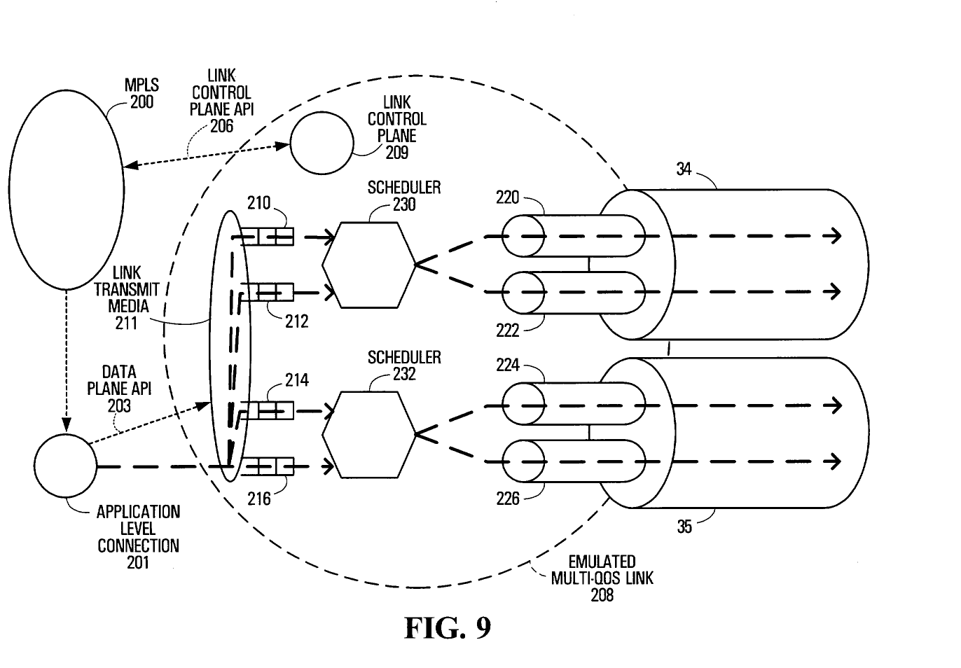

FIG. 9 illustrates an alternative embodiment of an emulated multi-QoS link 208 capable of transmitting messages over two separate interconnections while providing the appearance of one multi-QoS link to an application instance 200. Such an emulated multi-QoS link 208 could be implemented at a node such as node 14 of network 10 (FIG. 1) for example.

The emulated multi-QoS link is illustrated notionally at 208. Emulated multi-QoS link 208 includes four transmit queues 210, 212, 214 and 216 for enqueuing messages of different QoS levels which application 200 is desirous of transmitting over either interconnection 34 or interconnection 35.

Transmit queues 210 and 212 stores messages to be sent over interconnection 34 while transmit queues 214 and 216 stores messages to be sent over interconnection 35. As shown in FIG. 9, interconnections 34 and 35 both connect to the same node 20; this is a requirement (at least for the case where the application 200 is MPLS as in the present example).

Emulated multi-QoS link 208 further has a link control plane 209 which provides an API 206 for reporting link status and identifiers of transmit queues 210, 212, 214 and 216 to the application 200.

Emulated multi-QoS link 208 also includes link transmit media 211 which is responsible for enqueueing packets into transmit queues 210, 212, 214 and 216 based on QoS level. The link transmit media 211 is implemented in software and accordingly provides a data plane API 203 to facilitate the transmission of packets over link 208. The link transmit media 211 could alternatively be implemented in hardware, in which case no data plane API 203 would be provided.

Emulated multi-QoS link 208 further includes two schedulers 230 and 232 which schedule the transmission of messages by the emulated multi-QoS link 208 over connections 220, 222, 224 and 226. Connections 220, 222 exist on interconnection 34 while connections 224, 226 exist on interconnection 35.

In operation, the emulated multi-QoS link 208 will appear to the application 200 to provide one multi-QoS link, with the fact that certain QoS level messages are sent over interconnection 34 and other QoS level messages are sent over interconnection 35 being transparent to the application instance 200.

As will be appreciated by those skilled in the art, modifications to the above-described embodiments can be made without departing from the essence of the invention. For example, application instances may not necessarily be instances of MPLS in alternative embodiments. Rather, applications such as Internet Protocol (IP), Virtual LAN (VLAN), or the Dynamic Packet Routing System (DPRS) Trunk protocol used with Passport® switches from Nortel Networks®, could be employed at the application layer. In such cases, the applications may not be capable of creating E-LSPs, but rather may create analogous data paths at the application layer. Also, routing/switching may not be performed on the basis of a label (as for MPLS), but rather may be performed on the basis of a tag (in the case of VLAN), IP address (for IP), or a routing identifier (in the case of the DPRS protocol).

Data link layer protocols other than ATM or Gigabit Ethernet may be employed in alternative embodiments. For example, Frame Relay could be employed as a connection-oriented protocol, in which case connections would be identified by Data Link Connection Identifiers (DLCIs). Alternatively, Time Division Multiplexing could be employed as a connection-oriented protocol. Alternative non-connection-oriented protocols may include Packet Over Sonet (POS).

Also, it is not necessary for a single application to be associated with both the ingress and egress sides of a network node as in the described embodiment (e.g. instance 100 in FIGS. 3 and 4). Alternative embodiments may employ different applications for ingress and egress.

Other modifications will be apparent to those skilled in the art and, therefore, the invention is defined in the claims.

1. A method of emulating a multi-QoS (Quality of Service) link, comprising:
from an application-level Connection, providing messages of various QoS levels for transmission as to a multi-QoS link capable of transmitting messages of various QoS levels; and
transmitting each of said provided messages of a particular QoS level over one of a plurality of connections established by a connection-oriented protocol at the Open System Interconnections (OSI) data link layer suitable for transmitting messages of said particular QoS level.

2. The method of claim 1, further comprising:
receiving messages of various QoS levels over said plurality of connections; and
presenting said received messages to said application-level Connection as having been received over a multi-QoS link capable of receiving messages of various QoS levels.

3. The method of claim 1 further comprising providing a status of said emulated multi-QoS link to an application managing said application-level Connection.

4. The method of claim 3 wherein said providing a status comprises providing an indication from said emulated multi-QoS link to said application of whether said emulated multi-QoS link is operational or non-operational based on a status of each of said plurality of connections.

5. The method of claim 4 wherein said providing an indication comprises providing a status of operational when each of said plurality of connections is operational, and providing a status of non-operational otherwise.

6. The method of claim 4 wherein said providing an indication comprises providing a status of operational when at least one of said plurality of connections is operational, and providing a status of non-operational otherwise.

7. The method of claim 2 further comprising providing identifiers of queues used for said receiving or said transmitting to an application managing said application-level Connection.

8. The method of claim 1 wherein said connection-oriented protocol is selected from the set consisting of Asynchronous Transfer Mode (ATM), Frame Relay, and Time Division Multiplexing (TDM).

9. The method of claim 1 wherein said application-level Connection is managed by an application selected from the set consisting of the Multi-Protocol Label Switching (MPLS) framework of functions, Virtual Local Area Network (VLAN), and the Dynamic Packet Routing System (DPRS) trunk protocol.

10. The method of claim 1 wherein said plurality of connections is carried by a first interconnection, and further comprising:
from said application-level Connection, additionally providing messages of various QoS levels for transmission as to a multi-QoS link capable of transmitting messages of various QoS levels; and
transmitting said additionally provided messages over a further plurality of connections established by a connection-oriented protocol at the OSI data link layer, said further plurality of connections being carried by a second interconnection.

11. The method of claim 10 further comprising:
additionally receiving messages of various QoS levels over said at least one communications link; and
presenting said additionally received messages to said application-level Connection as having been received over said multi-QoS link.

12. The method of claim 1 further comprising:
from said application-level Connection, additionally providing messages of various QoS levels for transmission as to a multi-QoS link capable of transmitting messages of various QoS levels; and
transmitting said additionally provided messages over a communications link employing a non connection-oriented protocol at the OSI data link layer.

13. The method of claim 12 further comprising:
additionally receiving messages of various QoS levels over said communications link; and
presenting said additionally received messages to said application-level Connection as having been received over a multi-QoS link capable of receiving messages of various QoS levels.

14. The method of claim 13 wherein said non connection-oriented protocol is selected from the set consisting of Packet Over Sonet (POS) and Ethernet.

15. The method of claim 1 wherein said application-level Connection is an EXP-Inferred-PSC Label Switched Path (E-LSP).

16. A computer readable medium storing computer-executable instructions which, when performed by a processor in a computing device, cause the computing device to emulate a multi-QoS (Quality of Service) link by:
from an application-level Connection, providing messages of various QoS levels for transmission as to a multi-QoS link capable of transmitting messages of various QoS levels; and
transmitting each of said provided messages of a particular QoS level over one of a plurality of connections established by a connection-oriented protocol at the Open System Interconnections (OSI) data link layer suitable for transmitting messages of said particular QoS level.

17. The computer readable medium of claim 16 wherein said computer-executable instructions further cause the computing device to:
receive messages of various QoS levels over said plurality of connections; and
present said received messages to said application-level Connection as having been received over a multi-QoS link capable of receiving messages of various QoS levels.

18. The computer readable medium of claim 16 wherein said computer-executable instructions further cause the computing device to provide a status of said emulated multi-QoS link to an application managing said application-level Connection.

19. The computer readable medium of claim 18 wherein said providing a status comprises providing an indication from said emulated multi-QoS link to said application of whether said emulated multi-QoS link is operational or non-operational based on a status of each of said plurality of connections.

20. The computer readable medium of claim 19 wherein said providing an indication comprises providing a status of operational when each of said plurality of connections is operational, and providing a status of non-operational otherwise.

21. The computer readable medium of claim 19 wherein said providing an indication comprises providing a status of operational when at least one of said plurality of connections is operational, and providing a status of non-operational otherwise.

22. The computer readable medium of claim 17 wherein said computer-executable instructions further cause the computing device to provide identifiers of queues used for said receiving or said transmitting to an application managing said application-level Connection.

23. The computer readable medium of claim 16 wherein said connection-oriented protocol is selected from the set consisting of Asynchronous Transfer Mode (ATM), Frame Relay, and Time Division Multiplexing (TDM).

24. The computer readable medium of claim 16 wherein said application-level Connection is managed by an application selected from the set consisting of the Multi-Protocol Label Switching (MPLS) framework of functions, Virtual Local Area Network (VLAN), and the Dynamic Packet Routing System (DPRS) trunk protocol.

25. The computer readable medium of claim 16 wherein said plurality of connections is carried by a first interconnection and wherein said computer-executable instructions further cause the computing device to:
from said application-level Connection, additionally provide messages of various QoS levels for transmission as to a multi-QoS link capable of transmitting messages of various QoS levels; and
transmit said additionally provided messages over a further plurality of connections established by a connection-oriented protocol at the OSI data link layer, said further plurality of connections being carried by a second interconnection.

26. The computer readable medium of claim 25 wherein said computer-executable instructions further cause the computing device to:
additionally receive messages of various QoS levels over said communications link; and
present said additionally received messages to said application-level Connection as having been received over a multi-QoS link capable of receiving messages of various QoS levels.

27. The computer readable medium of claim 16 wherein said computer-executable instructions further cause the computing device to:
from said application-level Connection, additionally provide messages of various QoS levels for transmission as to a multi-QoS link capable of transmitting messages of various QoS levels; and
transmit said additionally provided messages over a communications link employing a non connection-oriented protocol at the OSI data link layer.

28. The computer readable medium of claim 27 wherein said computer-executable instructions further cause the computing device to:
additionally receive messages of various QoS levels over said communications link; and
present said additionally received messages to said application-level Connection as having been received over a multi-QoS link capable of receiving messages of various QoS levels.

29. The computer readable medium of claim 28 wherein said non connection-oriented protocol is selected from the set consisting of Packet Over Sonet (POS) and Ethernet.

30. The computer readable medium of claim 16 wherein said application-level Connection is an EXP-Inferred-PSC Label Switched Path (E-LSP).

31. A computing device for emulating a multi-QoS (Quality of Service) link operable to:
from an application-level Connection, provide messages of various QoS levels for transmission as to a multi-QoS link capable of transmitting messages of various QoS levels; and
transmit each of said provided messages of a particular QoS level over one of a plurality of connections established by a connection-oriented protocol at the Open System Interconnections (OSI) data link layer suitable for transmitting messages of said particular QoS level.

32. The computing device of claim 31 further operable to:
receive messages of various QoS levels over said plurality of connections; and
present said received messages to said application-level Connection as having been received over a multi-QoS link capable of receiving messages of various QoS levels.

33. The computing device of claim 31 further operable to provide a status of said emulated multi-QoS link to an application managing said application-level Connection.

34. The computing device of claim 33 wherein said providing a status comprises providing an indication from said emulated multi-QoS link to said application of whether said emulated multi-QoS link is operational or non-operational based on a status of each of said plurality of connections.

35. The computing device of claim 34 wherein said providing an indication comprises providing a status of operational when each of said plurality of connections is operational, and providing a status of non-operational otherwise.

36. The computing device of claim 34 wherein said providing an indication comprises providing a status of operational when at least one of said plurality of connections is operational, and providing a status of non-operational otherwise.

37. The computing device of claim 32 further operable to provide identifiers of queues used for said receiving or said transmitting to an application managing said application-level Connection.

38. The computing device of claim 31 wherein said connection-oriented protocol is selected from the set consisting of Asynchronous Transfer Mode (ATM), Frame Relay, and Time Division Multiplexing (TDM).

39. The computing device of claim 31 wherein said application-level Connection is managed by an application selected from the set consisting of the Multi-Protocol Label Switching (MPLS) framework of functions, Virtual Local Area Network (VLAN), and the Dynamic Packet Routing System (DPRS) trunk protocol.

40. The computing device of claim 31 further operable to:
from said application-level Connection, additionally provide messages of various QoS levels for transmission as to a multi-QoS link capable of transmitting messages of various QoS levels; and
transmit said additionally provided messages over a communications link employing a non connection-oriented protocol at the OSI data link layer.

41. The computing device of claim 40 further operable to:
additionally receive messages of various QoS levels over said communications link; and
present said additionally received messages to said application-level Connection as having been received over a multi-QoS link capable of receiving messages of various QoS levels.

42. The computing device of claim 31 further operable to:
from said application-level Connection, additionally provide messages of various QoS levels for transmission as to a multi-QoS link capable of transmitting messages of various QoS levels; and
transmit said additionally provided messages over a communications link employing a non connection-oriented protocol at the OSI data link layer.

43. The computing device of claim 42 further operable to:
additionally receive messages of various QoS levels over said communications link; and
present said additionally received messages to said application-level Connection as having been received over a multi-QoS link capable of receiving messages of various QoS levels.

44. The computing device of claim 43 wherein said non connection-oriented protocol is selected from the set consisting of Packet Over Sonet (POS) and Ethernet.

45. The computing device of claim 31 wherein said application-level Connection is an EXP-Inferred-PSC Label Switched Path (E-LSP).

46. An Application Programming Interface (API) having functions comprising:
link status functions capable of:
indicating a status of an emulated multi-QoS link capable of carrying messages of various QoS (Quality of Service) levels over a plurality of connections established by a connection-oriented protocol at the Open System Interconnections (OSI) data link layer, said status being based on the operational status of said connections.

47. The API of claim 46 wherein said indicating indicates a status of operational for said emulated multi-QoS link when each of said plurality of connections is operational, and wherein said indicating indicates a status of non-operational otherwise.

48. The API of claim 46 wherein said indicating indicates a status of operational for said emulated multi-QoS link when at least one of said plurality of connections is operational, and wherein said indicating indicates a status of non-operational otherwise.

49. An Application Programming Interface (API) having functions comprising:
message transmitting functions capable of:
from an application-level Connection, receiving messages of various QoS (Quality of Service) levels which have been provided for transmission as to a multi-QoS link capable of transmitting messages of various QoS levels; and
transmitting each of said provided messages of a particular QoS level over one of a plurality of connections suitable for transmitting messages of said particular QoS level,
whereby the application-level Connection regards said API to be that of a multi-QoS link.

50. A computer readable medium storing computer-executable instructions which, when performed by a processor in a computing device, cause the computing device to:
from an application-level Connection, provide messages of various QoS levels for transmission as to a multi-QoS link capable of transmitting messages of various QoS levels; and
transmit each of said provided messages of a particular QoS level over one of a plurality of single-QoS links suitable for transmitting messages of said particular QoS level.
